(19) United States
(12) Patent Application Publication
(10) Pub. No.: US 2007/0190981 A1
(43) Pub. Date: Aug. 16, 2007

(54) Phonebook management for a mobile terminal

(75) Inventor: Yair Winkler, Caesarea (IL)

Correspondence Address: BROWDY AND NEIMARK, P.L.L.C.;624 NINTH STREET, NW, SUITE 300, WASHINGTON, DC, 20001-5303, US

(73) Assignee: Festin Enterprises Corporation, Der Stadt (PA)

(21) Appl. No.: 11/354,856

(22) Filed: Feb. 16, 2006

(51) Int. Cl. H04Q 7/38

(52) U.S. Cl. 455/414.1

(57) ABSTRACT

The present invention relates to a telecommunication system and methods for searching for a personal phone number or contact information, or both, using a mobile terminal. A communication server gathers in its coupled central address database phone numbers and contact information from different sources. All the numbers dialed-out by the subscriber are logged in said database. All incoming calls, wherein the caller's number is available, are also logged in said database. In addition, the communication server can import available contact information from other sources such as a Personal Information Manager (PIM) application on a personal computer for example Microsoft Outlook, a database program, a spreadsheet, any other computer data file, or from a Personal Digital Assistant (PDA). The subscriber may also interact directly with the database in order to add, modify or remove contact information.

### FIELD OF THE INVENTION

The present invention relates to a telecommunication system and methods to enable a subscriber to search for a phone number or contact information on his mobile terminal.

### BACKGROUND OF THE INVENTION

Personal and professional phone numbers and contact information can be stored in a variety of places including a paper phone book, a personal computer, a personal digital assistant (PDA), or a mobile phone or terminal to name a few popular choices. When people are mobile, out of the house or office, the mobile phone or terminal can be the best tool to locate and dial out a phone number efficiently. If a phone number is stored on a different location such as a paper diary or a personal computer, then the phone number needs to be first located and then keyed by using the mobile phone's keypad, which makes the process of locating a phone number and dialing it longer and more cumbersome.

While a mobile phone can be efficient and fast in locating a phone number and dialing it out, it is still an awkward tool for initially entering phone numbers into its phone book. Mobile phones, except some minor advanced smart phones, only have a numeric keypad. Thus entering names is a time consuming process. It would be desirable to be able to enter phone numbers in a more comfortable environment, such as a personal computer, and then make these phone numbers available in the mobile phone.

Phone numbers along with the corresponding name, and additional optional contact information, can be saved to a mobile phone in several ways. Many phones such as European GSM (Global System for Mobile Communications) phones or North-American PCS (Personal Communication Services) phones come with a Subscriber Identity Module (SIM) smart card that contains personal account information. Subscribers can store their personal phone numbers on the SIM card. When changing phones, subscribers plug in their SIM cards, and all their personal phone numbers on it are immediately available on the new phone.

Some advanced phones offer another way of saving phone numbers and contact information by directly entering it into the mobile phone's memory. The telephone's memory is typically larger than the SIM's available memory and thus subscribers can store more contacts on a phone's memory than on a SIM smart card. In addition, many mobile phones offer additional features and allow subscribers to save additional fields if the contacts are saved in the phone's memory instead of the SIM. In a SIM card, a subscriber can only save a telephone number and a corresponding name. In contrast, some telephones allow a subscriber to specify for each contact additional information such as: all the phone numbers of said contact (work, home, mobile, fax), an email address, street address and general notes.

Subscribers tend to change or upgrade mobile phones frequently. In addition, a subscriber may lose its mobile phone or happen to rent out an additional mobile phone when in a foreign country.

If a subscriber keeps his phone numbers in the SIM card, then if he plugs it into a new mobile phone, all his contacts will be available again. The disadvantage, as mentioned above, is that he can keep less contacts and less information about each one.

When a subscriber loses its mobile phone along with its SIM card, then all his contacts are lost, and he would need to retype them into the new phone. If a subscriber saved his contacts in the phone's memory, then he would also be required to input them again into any new phone. It would be desirable to enable subscribers to enjoy access to their contacts from their mobile phone, without needing to re-input them for any new phone they acquire. It would also be desirable to be able to enjoy access to all the contacts that were entered into the subscriber's computer.

### SUMMARY OF THE INVENTION

The present invention relates to a telecommunication system and methods for searching for a personal phone number or contact information, or both, using a mobile terminal. A communication server gathers in its coupled central address database phone numbers and contact information from different sources. All the numbers dialed-out by the subscriber are logged in said database. All incoming calls, wherein the caller's number is available, are also logged in said database. In addition, the communication server can import available contact information from other sources such as a Personal Information Manager (PIM) application on a personal computer for example Microsoft Outlook, a database program, a spreadsheet, any other computer data file, or from a Personal Digital Assistant (PDA). The subscriber may also interact directly with the database in order to add, modify or remove contact information.

The communication server updates the mobile phone book in the mobile terminal with relevant phone numbers and contact information according to predefined rules. The subscriber is able to modify and customize these rules. The mobile terminal communicates with said communication server to verify that the mobile phone book contains all the required telephone numbers and contact information for the specific geographic zone the mobile terminal is situated. If necessary, new telephone numbers and contact information are downloaded from the central address database to the mobile phone book.

The subscriber can search for a telephone number according to several search criteria including at least one of the following search criteria: first name, last name, company name, phone number, prefix, area code, country code, mobile operator, date call was issued, date call was received, frequency of calls, or source of phone number in central address book.

Phone numbers are searched first within the mobile phone book of the mobile terminal. If the phone number is not found, the search can be expanded also to the central address database.

### BRIEF DESCRIPTION OF THE DRAWINGS

FIG. 1 is a block diagram of a telecommunication system of the invention comprising a mobile terminal with its mobile phone book, and a communication server coupled with a central address database.

FIG. 2 shows a communication server coupled with a central address database, connected with a personal digital assistant and a personal computer that contains a personal information manager, a database and a spreadsheet.

FIG. 3 shows the central address database wherein contacts are divided into three categories: permanent phone records, country default phone records and archived phone records.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

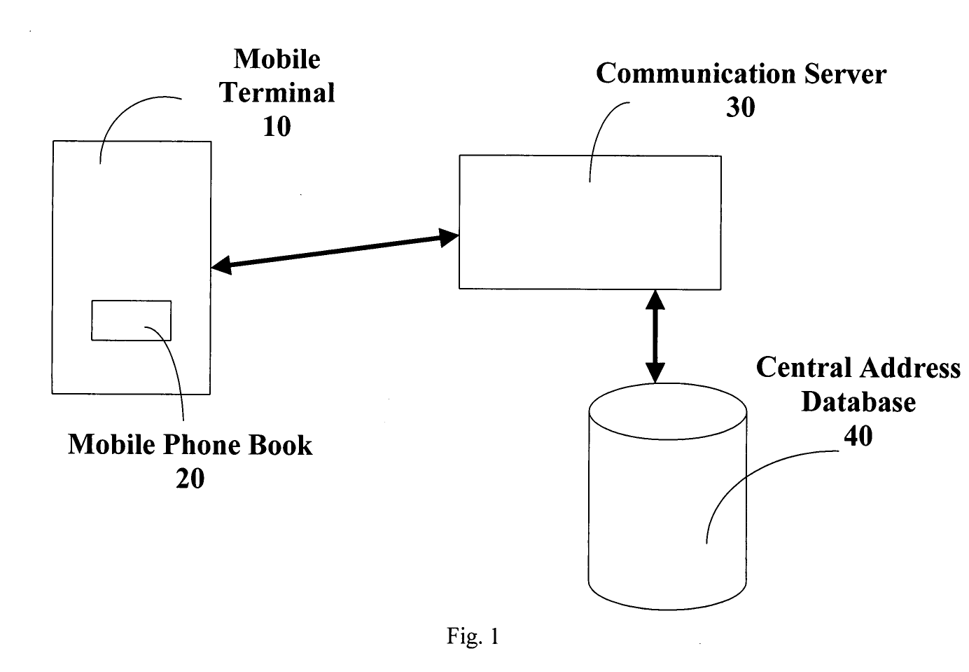

The present invention relates to a system and methods for searching for a personal phone number or contact information, or both, using a mobile terminal. FIG. 1 shows a block diagram of a telecommunication system of the invention comprising a mobile terminal 10, running a mobile phone book application 20, said mobile terminal 10 communicating with a communication server 30 coupled with a central address database 40.

The communication server 30 gathers and logs phone numbers and contact information from different sources into a central address database 40. The communication server 30 sends the mobile terminal 10 phone records containing phone numbers and contact information either on demand from said mobile terminal 10 or upon determination by said communication server 30, based on predefined rules, when the mobile phone book 20 needs to be updated. In one embodiment of the present invention, said predefined rules can be customized by the subscriber.

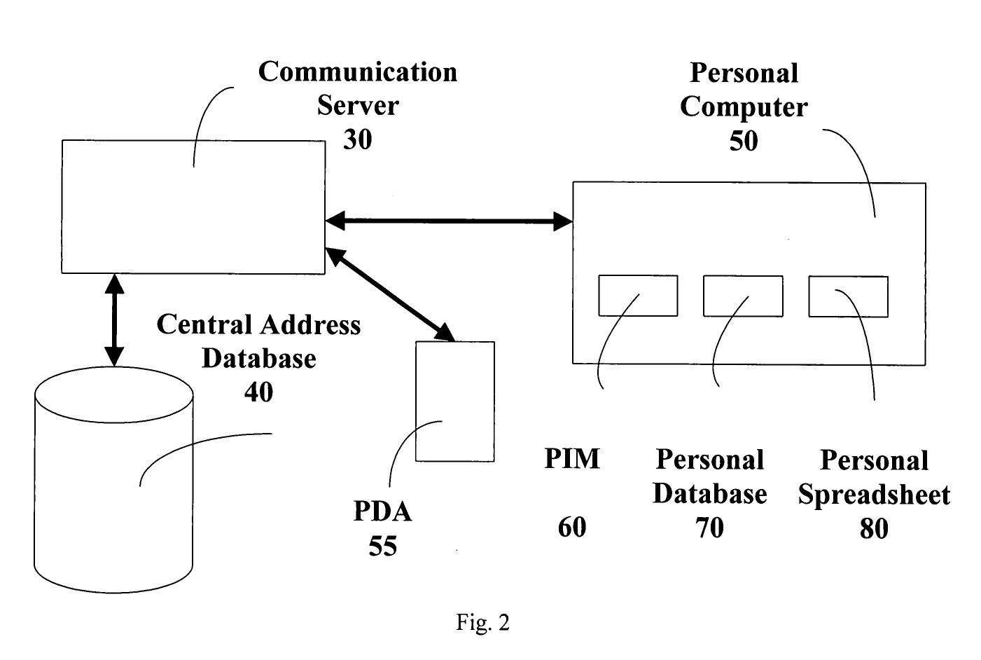

FIG. 2 illustrates a block diagram of a communication server 30 coupled with a central address database 40, communicating with a personal computer 50 and a Personal Digital Assistant (PDA) 55. The personal computer 50 contains applications that can manage phone numbers and contact information. These applications can be a Personal Information Manager (PIM) 60, a personal database 70 or a personal spreadsheet 80. The above-mentioned applications are only described as examples of applications that can store and manage phone numbers and contact information. The communication server 30 of the present invention can communicate and receive phone numbers and contact information from other applications and files on a personal computer 50. The PDA 55 is also a popular tool for managing phone numbers and contact information.

The communication server 30 gathers and logs phone numbers and contact information from applications and files on a personal compute 50 or PDA 55 into the central address database 40. The communication server 30 also logs all outgoing communications from the mobile terminal 10, and all incoming calls to the mobile terminal 10 where the caller's phone number is made available. In one embodiment of the present invention, the subscriber is provided with tools for adding, modifying and removing phone numbers and contact information from said central address database 40. In addition to editing existing information, this feature can be very helpful in several scenarios. For example, a subscriber may get the phone number of a good local restaurant and call it to make a reservation. After eating at the restaurant, the subscriber may decide to keep the number for a future visit. The phone number is kept by default at the address database 40 with the phone number dialed out, and the date, time and duration of the call. The subscriber can edit the record in the address database 40 and add additional information such as the restaurant's name, opening hours and any other information he may wish to keep. These capabilities make it easier for the subscriber to find the phone number and contact information of the restaurant in the future.

When a subscriber searches for a phone number or contact information, the search is performed first locally in the mobile terminal's 10 mobile phone book 20, and if necessary in the central address database 40 coupled with the communication server 30.

In another embodiment of the present invention, subscribers can search for phone numbers and contact information according to predefined criteria. In a further embodiment of the present invention, subscribers can modify or customize the default search criteria. The subscriber can use more than one search criteria in order to find the right phone number or contact information. The search criteria includes at least one of the following fields: first name, last name, company name, phone number, prefix, area code, country code, mobile operator, date call was issued, date call was received, frequency of calls, or source of phone number in central address book. Following are several examples of search criteria that a subscriber can provide. The examples are described in general English language; their implementation on each mobile terminal will be adapted to the terminal's operating environment:
I called this number in Rome at least 3 times last month
First name is Henry and the Swiss mobile operator is XYZ
The contact record came from Outlook on my personal computer and I received a call yesterday
The last name is Ryan and he works for ACME

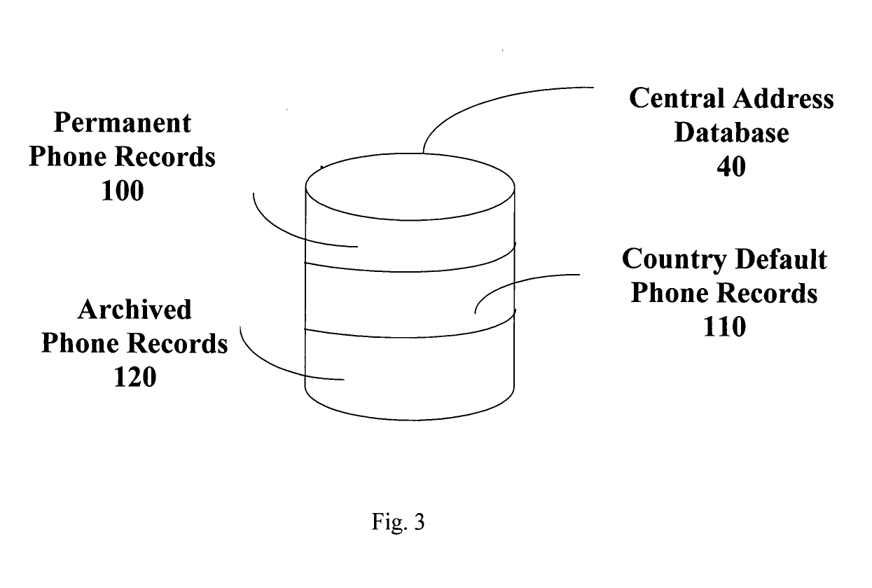

Phone records, containing phone numbers and contact information, stored in the central address database 40 are divided into several categories. FIG. 3 shows an implementation of the present invention wherein phone records are divided into three categories.

The first category includes permanent phone records 100, which are phone numbers and contact information that the subscriber would like to always have available in the mobile phone book 20. Permanent phone records 100 can typically include phone numbers and contact information of: close family members, friends, work colleagues, professional contacts, emergency numbers, and different information services that the subscriber tends to use. Permanent phone records 100 are always available in the mobile phone book 20.

The second category includes country default phone records 110, which are phone numbers and contact information that are only necessary to the subscriber when he is visiting that country. Country default phone records 110 can typically include phone numbers and contact information of: local restaurants and services, and personal and professional contacts that the subscriber only calls when in the country. Country default phone records 110 are loaded to the mobile phone book 20 when the subscriber is in said country.

The third category includes the archived phone records 120 and includes all the phone numbers and contact information that are not in the permanent phone records 100 or country default phone records 110. These phone numbers will not be sent to the mobile terminal's 10 mobile phone book 20, but can nevertheless be searched from the central address database 40 when necessary.

The subscriber retains control of the categories and can select and modify the category of each phone record.

In one embodiment of the present invention, phone records are sent from the central address database 40 to the mobile phone book 20 according to predefined rules. In another embodiment of the present invention, said predefined rules can be modified or customized by the subscriber.

The mobile terminal 10 communicates with the communication server 20 to check the status of the contents of the mobile phone book 30 against the central address database 40, and to verify if phone records need to be added, removed or updated from mobile phone book 30. Occasions when said status is checked include but are not limited to: when the mobile terminal 10 is turned on, when the mobile terminal 10 connects to a new mobile operator, on preset time intervals, on predefined dates, and when the subscriber initiates a status check.

In yet another implementation of the present invention phone numbers and contact information are sent from the central address database 40 to the mobile phone book 20 via an Over The Air (OTA) application server.

OTA is a very convenient way for updating the mobile phone book 30 when necessary. One advantage that OTA has over other methods for sending information to a mobile terminal 10 is that OTA is aware if the mobile terminal 10 is turned on and can receive messages, or if it is not available in the network. A mobile terminal 10 may be either turned off or in a zone without adequate network coverage. Once the mobile terminal 10 is confirmed to be available in the mobile network, the mobile terminal 10 receives one or more hidden short messages (SMS) with the pertinent information regarding phone numbers and contact information that needs to be updated in the mobile phone book 30.

1. A telecommunication system for searching for a phone number or contact information or both using a mobile terminal, said system comprising:
(i) means for gathering phone numbers and contact information into a central address database coupled with a communication server;
(ii) means for sending said phone numbers and contact information from said central address database to a mobile phone book in said mobile terminal; and
(iii) means for searching for a phone number or contact information or both, within said mobile phone book or said central address database, using said mobile terminal.

2. The telecommunication system according to claim 1, wherein said phone numbers or contact information are searched according to subscriber defined search criteria.

3. The telecommunication system according to claim 2, wherein said subscriber defined search criteria includes at least one of the following fields: first name, last name, company name, phone number, prefix, area code, country code, mobile operator, date call was issued, date call was received, frequency of calls, or source of phone number in said central address database.

4. The telecommunication system according to claim 1, wherein said central address database is divided into several categories.

5. The telecommunication system according to claim 4, wherein said categories include: permanent phone records, country default phone records, and other archived phone records.

6. The telecommunication system according to claim 1, wherein phone records are downloaded or updated from said central address database to said mobile phone book according to predefined rules.

7. The telecommunication system according to claim 6, wherein said predefined rules are to download or update from said central address database to said mobile phone book all permanent phone records, and country-default phone records for the country in which said mobile terminal is currently located.

8. The telecommunication system according to claim 6, wherein said predefined rule are customized by the subscriber.

9. The telecommunication system according to claim 1, wherein said phone numbers or contact information, or both, are downloaded or updated from said central address database to said mobile phone book via an Over The Air (OTA) application server.

10. A method for searching for a phone number or contact information or both using a mobile terminal, said method comprising the steps of:
(i) gathering phone numbers and contact information into a central address database coupled with a communication server;
(ii) sending said phone numbers and contact information from said central address database to a mobile phone book in said mobile terminal; and
(iii) searching for a phone number or contact information or both, within said mobile phone book or said central address database, using said mobile terminal.

11. The method according to claim 10, wherein said phone numbers or contact information are searched according to subscriber defined search criteria.

12. The method according to claim 11, wherein said subscriber defined search criteria includes at least one of the following fields: first name, last name, company name, phone number, prefix, area code, country code, mobile operator, date call was issued, date call was received, frequency of calls, or source of phone number in said central address database.

13. The method according to claim 10, wherein said central address database is divided into several categories.

14. The method according to claim 13, wherein said categories include: permanent phone records, country default phone records, and other archived phone records.

15. The method according to claim 10, wherein phone records are downloaded or updated from said central address database to said mobile phone book according to predefined rules.

16. The method according to claim 15, wherein said predefined rules are to download or update from said central address database to said mobile phone book all permanent phone records, and country-default phone records for the country in which said mobile terminal is currently located.

17. The method according to claim 15, wherein said predefined rule are customized by the subscriber.

18. The method according to claim 10, wherein said phone numbers or contact information, or both, are downloaded or updated from said central address database to said mobile phone book via an Over The Air (OTA) application server.
